(19) United States
(12) Patent Application Publication
(10) Pub. No.: US 2007/0029909 A1
(43) Pub. Date: Feb. 8, 2007

(54) Plasma display panel

(76) Inventor: Dong-Hyun Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/493,001

(22) Filed: Jul. 26, 2006

(30) Foreign Application Priority Data
Aug. 6, 2005 (KR) 10-2005-0072009

(51) Int. Cl. H01J 21/10

(52) U.S. Cl. 313/306

(57) ABSTRACT

A plasma display panel (PDP) with improved brightness and reduced power consumption that is easy to manufacture may include first and second substrates facing each other and separated by a predetermined distance, and a plurality of pairs of sustain electrodes that are interposed between the first and second substrates and generate discharge. Each of the sustain electrodes may include a plurality of electrode portions and connecting portions that electrically connect the electrode portions. A relative ratio (S/B) of line widths (B) of one of the electrode portions to line widths (S) of one of the connecting portions may satisfy a relationship of 1.00≦S/B≦1.70.

### BACKGROUND OF THE INVENTION

1. Field of the Invention

The invention relates to plasma display panels (PDPs). More particularly, the invention relates to electrodes of PDPs, and PDPs employing such an electrode structure, which can be easily manufactured, have high brightness, and low power consumption.

2. Description of the Related Art

PDPs, which are being used as substitutes for conventional cathode ray tubes (CRTs), are display devices that display images by applying a discharge voltage to a discharge gas between two substrates. Electrodes on the substrates may be driven to generate ultraviolet (UV) rays, which may excite a phosphor material provided between the substrates.

FIG. 1 illustrates a known alternating current (AC) three-electrode type surface discharge PDP 10. As shown in FIG. 1, the PDP 10 may include an upper panel 50 on which an image may be displayed to a user, and a lower panel 60, which may be coupled in parallel with the upper panel 50. The upper panel 50 may include pairs of sustain electrodes 12 disposed on a front substrate 11, each pair of sustain electrodes 12 may include an X electrode 31 and a Y electrode 32. Address electrodes 22 may be disposed on a back substrate 21 of the lower panel 60 and may be arranged to be perpendicular to the X and Y electrodes 31 and 32. A first dielectric layer 15 and a second dielectric layer 25 may be respectively formed on a surface of the front substrate 11 and a surface of the back substrate 21 to cover the sustain electrodes 12 and the address electrodes 22. A protective layer 16 made of, e.g., MgO, may be formed on a back surface of the first dielectric layer 15. Barrier ribs 30 for maintaining discharge distance and preventing electrical and optical cross-talk between discharge cells 70 may be disposed on a front surface of the second dielectric layer 25. Phosphors 26, e.g., red, green, and blue phosphors, may be deposited on sides of the barrier ribs 30 and portions of the front surface of the second dielectric layer 25 where the barrier ribs 30 are not formed.

Each of the X electrodes 31 may include a transparent electrode 31a and a bus electrode 31b, and each of the Y electrodes 32 may include a transparent electrode 32a and a bus electrode 32b. Overlapping portions of a pair of the X and Y electrodes 31 and 32 and one of the address electrodes 22, which crosses the pair of the X and Y electrodes 31 and 32, respectively form a discharge cell 70, i.e., a discharge unit. The transparent electrodes 31a and 32a may be made of transparent, conductive materials, e.g., indium tin oxide (ITO), which may cause discharge while allowing light emitted from the phosphor layer 26 to be transmitted to the front substrate 11, i.e., not blocking the light emitted from the phosphor layer 26 from being transmitted to the front substrate 11. However, generally such transparent, conductive materials, e.g., ITO, have a high resistance. Thus, if discharge sustain electrodes include only transparent electrodes 31a and 32a, a voltage drop along the sustain electrodes 12 increases, resulting in higher driving power consumption and a reduction in response speed. To overcome disadvantages, the bus electrodes 31b and 32b made of conductive material(s), e.g., metal, are respectively formed on the transparent electrodes 31a and 32b. The conductive material(s) used for the bus electrodes 31a and 32b are not transparent and block the light emitted from the phosphor layers 26 from being transmitted to the front substrate 11. Thus, the bus electrodes 31b and 32b are formed to have a narrow width so that light emitted from the phosphor layers 26 can be transmitted to the front substrate 11.

Separate processes are required for forming the bus and transparent electrodes of the sustain electrodes. Thus, the cost and manufacturing time of such PDPs are increased

Thus, techniques of forming sustain electrodes with only bus electrodes are in development. However, brightness is low when using a typical bus electrode structure.

### SUMMARY OF THE INVENTION

The present invention is therefore directed to an electrode structure of a PDP and PDPs employing such an electrode structure, which substantially overcome one or more of the problems due to the limitations and disadvantages of the related art.

It is therefore a feature of an embodiment of the invention to provide a PDP that can be easily manufactured.

It is therefore a separate feature of an embodiment of the invention to provide a PDP with high brightness.

It is therefore a separate feature of an embodiment of the invention to provide a PDP with low power consumption.

It is therefore a separate feature of embodiments of the invention to provide a PDP having particular line widths for electrode portions and connecting portions of sustain electrodes, which increase brightness and reduce power consumption.

It is therefore a separate feature of embodiments of the invention to provide a PDP that may employ sustain electrodes that may be formed during a single processing step and/or employing one type of material, thereby reducing a cost of the PDP and/or simplifying the manufacturing process of the PDP.

At least one of the above and other features and advantages of the invention may be realized by providing a plasma display panel (PDP) including first and second substrates facing each other and separated by a predetermined distance, and a plurality of pairs of sustain electrodes that are interposed between the first and second substrates for generating discharge, each of the plurality of pairs of sustain electrodes including a plurality of electrode portions, and connecting portions which electrically connect the electrode portions, wherein a relative ratio (S/B) of line widths (B) of one of the electrode portions to line widths (S) of one of the connecting portions satisfies a relationship of 1.00≦S/B≦1.70.

The electrode portions of each sustain electrode may extend parallel to each other. Each sustain electrode may include two to four electrode portions extending parallel to each other. The connecting portions and the electrode portions may extend perpendicular to one another. The line widths of the electrode portions may be about 20 μm to about 150 μm. The line widths of the electrode portions of each sustain electrode may be substantially equal. The connecting portions and the electrode portions of each sustain electrode may be integrated. The connecting portions may be disposed at substantially center portions of the discharge cells.

The sustain electrodes may be made of at least one of a conductive metal material and a ceramic material. The sustain electrodes may be made of at least one metal material selected from the group consisting of Ag, Pt, Pd, Ni and Cu. The sustain electrodes may be formed of at least one of indium doped tin oxide and antimony doped tin oxide. The sustain electrodes may include carbon nanotubes.

At least one of the above and other features and advantages of the invention may be separately realized by providing a PDP including first and second substrates facing each other and separated by a predetermined distance, a plurality of barrier rib units interposed between the first and second substrates and at least partially defining a plurality of discharge cells, address electrodes extending across the discharge cells, a plurality of pairs of sustain electrodes that intersect the address electrodes, may cause discharge, and may include a plurality of electrode portions that crosses the address electrodes and connecting portions which electrically connect the electrode portions, phosphor layers formed in the discharge cells, and discharge gas in the discharge cells, wherein a relative ratio (S/B) of line widths (B) of one of the electrode portions to line widths (S) of one of the connecting portions satisfies a relationship of 1.00≦S/B≦1.70.

The connecting portions of each sustain electrode may be disposed in each of the discharge cells. The PDP may include light absorbing layers for absorbing light incident from outside of the PDP. The barrier ribs may include first barrier ribs disposed parallel to the address electrodes extends, and second barrier ribs disposed intersecting the first barrier ribs, and the light absorbing layers may be disposed to at least partially overlap the second barrier ribs. The light absorbing layers may be formed in stripes.

The line widths of the light absorbing layers may be about 50 μm to about 200 μm. The PDP may further include a first dielectric layer covering the sustain electrodes, and a second dielectric layer covering the address electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a known PDP;

FIG. 2 illustrates an exploded perspective view of an exemplary embodiment of a PDP employing one or more aspects of the invention;

FIG. 3 illustrates a cross-sectional view of the PDP shown in FIG. 2 taken along line III-III of FIG. 2;

FIG. 4 illustrates a plan view of discharge cells and sustain electrodes illustrated in FIG. 2;

FIG. 5 illustrates a graph of full white brightness with respect to the relative ratio of line widths of connecting portions to line widths of electrode portions of sustain electrodes; and

FIG. 6 illustrates a graph of power consumption when performing the experiment of FIG. 5.

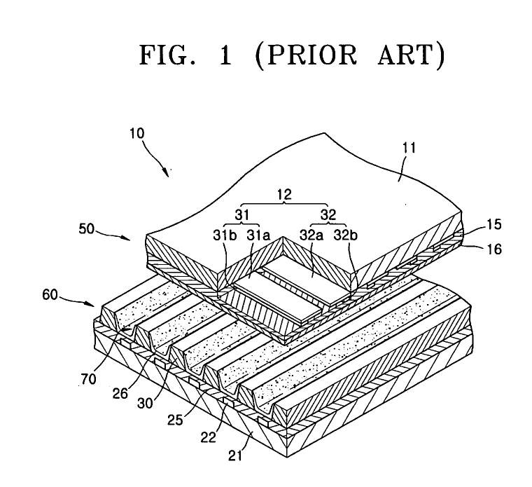

### DETAILED DESCRIPTION OF THE INVENTION

Korean Patent Application No. 10-2005-0072009, filed on Aug. 6, 2005, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

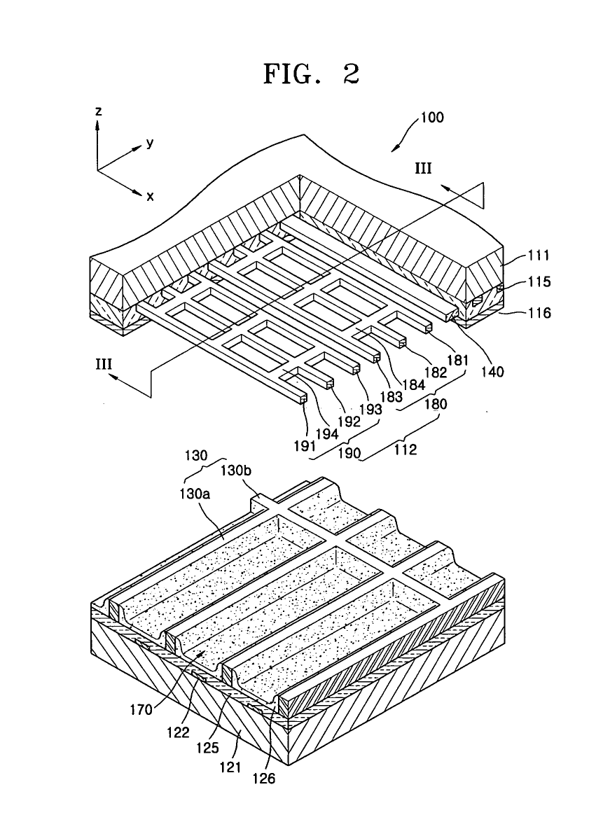

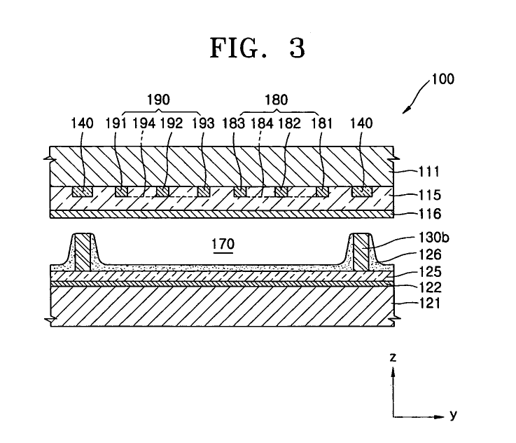

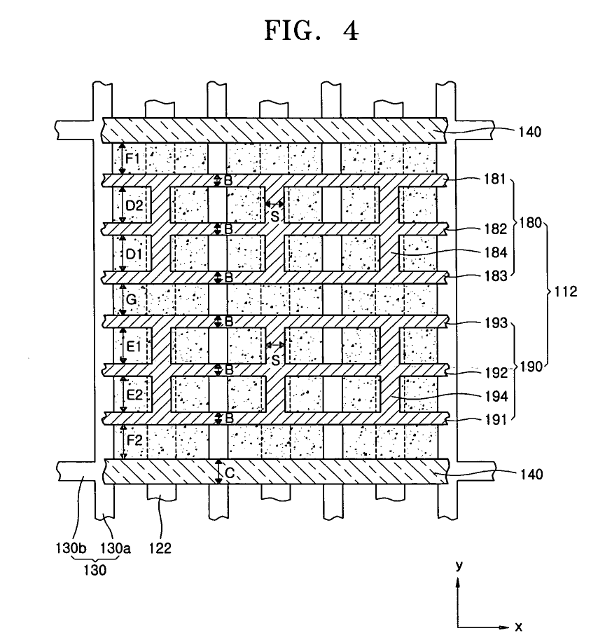

An exemplary embodiment of a plasma display panel (PDP) 100 is illustrated in FIGS. 2 through 4. FIG. 2 illustrates an exploded perspective view of the PDP 100, FIG. 3 illustrates a cross-sectional view of the PDP 100 shown in FIG. 2, along line III-III of FIG. 2, and FIG. 4 illustrates a plan view of discharge cells 170, a barrier rib unit 130, sustain electrodes 112, and address electrodes 122 illustrated in FIG. 2.

The PDP 100 may include a first substrate 111, a second substrate 121, pairs of sustain electrodes 112, the address electrodes 122, the barrier rib unit 130, a protective layer 116, phosphor layers 126, a first dielectric layer 115, a second dielectric layer 125, and a discharge gas (not shown).

The first substrate 111 may be made of a material with excellent light transmitting properties, e.g., glass. However, the first substrate 111 may be colored to reduce reflected light, thereby improving bright room contrast. The second substrate 121 may face the first substrate 111 and may be separated a predetermined distance from the first substrate 111. The second substrate 121 may be made of a material with excellent light transmitting properties, e.g., glass. The second substrate 121 may be colored to reduce reflected light.

In embodiments of the invention, visible rays generated from the discharge cells 170 may be emitted to the outside via the first substrate 111 and/or the second substrate 121. However, in the exemplary embodiment described below, the visible rays are emitted to the outside via the first substrate 111.

The barrier rib unit 130, which may at least partially define the discharge cells 170, may be interposed between the first and second substrates 111 and 121. A discharge may occur in the discharge cells 170. The barrier rib unit 130 may reduce and/or prevent optical cross talk between the discharge cells 170. In embodiments of the invention, the barrier rib unit 130 may include first barrier ribs 130a, which may extend parallel to the address electrodes 122, e.g., along a y-direction, and second barrier ribs 130b, which may extend substantially perpendicular to the first barrier ribs 130a, e.g., along an x-direction. The structure of the barrier ribs are not, however, limited to the above described structure, and may form an open-type-barrier-rib pattern, e.g., a striped pattern, or a closed-type-barrier-rib pattern, e.g., a waffle, matrix, or delta pattern, as long as discharge spaces can be formed. In the closed-type-barrier-rib pattern, a cross-section of the discharge space may be polygonal, e.g., triangular or pentagonal, circular or oval in addition to rectangular, as shown in the exemplary embodiment illustrated in FIGS. 2-4.

Pairs of sustain electrodes 112 may be arranged, e.g., in parallel, at predetermined intervals on a surface of the first substrate 111 that faces the second substrate 121. Each of the pairs of sustain electrodes 112 may include an X electrode 180 and a Y electrode 190. The X and Y electrodes 180 and 190 may cause plasma discharge in the discharge cells 170.

Each of the X electrodes 180 may include a plurality of portions, e.g., a first electrode portion 181, a second electrode portion 182, a third electrode portion 183, and connecting portions 184. The first electrode portion 181, the second electrode portion 182, and the third electrode portion 183 may be arranged, e.g., parallel to each other with a predetermined distance between them. The first electrode portion 181, the second electrode portion 182 and the third electrode portion 183 may extend perpendicular to the address electrodes 122, e.g., the x-direction. The first electrode portion 181, the second electrode portion 182, and the third electrode portion 183 may be sequentially arranged, such that, e.g., the first electrode portion 181 may be arranged substantially at one side of the discharge cell 170, the third electrode portion 183 may be arranged substantially at a center of the discharge cell 170, and the second electrode portion 182 may be arranged substantially between the first electrode portion 181 and the third electrode portion 183. As discussed below, a corresponding one of the Y electrodes 190 associated with the same discharge cell 170 may be symmetrically arranged, as discussed below, over the other side of the discharge cell 170.

In embodiments of the invention, each of the X electrodes 180 may include the first, second and third electrode portions 181, 182, and 183. However, the present invention is not limited to such a structure. That is, it is sufficient if each X electrode 180 includes a plurality of electrode portions, and may include more than three or less than three, e.g., 2, 4, 6, etc., electrode portions.

Each connecting portion 184 of one of the X electrodes 180 may electrically connect two adjacent ones of the first, second and third electrode portions 181, 182, and 183 of one of the X electrodes 180 together. As shown in FIG. 2, a plurality of connecting portions 184 may be associated with each discharge cell 170. In exemplary embodiments of the invention described herein, for connecting the first, second and third electrode portions 181, 182, 183 of one of the X electrodes 180 associated with one of the discharge cells 170, two connecting portions 184 extend substantially along a center of one of the discharge cells 170 and substantially perpendicular, i.e., along the y-direction. For example, one of the connecting portions 184 may connect the first electrode portion 181 to the second electrode portion 182, and another of the connecting portions 184 may connect the second electrode portion 182 to the third electrode portion 183.

In embodiments of the invention, the respective connecting portions 184 associated with one of the discharge cells 170 may be aligned, e.g., along the y-direction. In embodiments of the invention, the respective connecting portions 184 associated with one of the discharge cells 170 may not be aligned (not shown). In embodiments of the invention, portions 184 may be employed such that at least one of the connecting portions 184 exists between each adjacent pair of the electrode portions 181, 182, 183 of one of the X electrodes 180 associated with one of the discharge cells. However, the present invention is not limited to the arrangement described above.

The first, second, and third electrode portions 181, 182, and 183 and the connecting portions 184 of each of the X electrodes 180 may be made of various conductive materials, and may be made of a material containing, e.g., metallic elements or ceramic elements. Examples of the metallic elements include, e.g., Ag, Pt, Pd, Ni, and Cu, and examples of the ceramic elements include, e.g., indium doped tin oxide (ITO) and antimony doped tin oxide (ATO). The first, second, and third electrode portions 181, 182, and 183 and the connecting portions 184 of each of the X electrodes 180 may be made of a material containing, e.g., carbon nanotubes, to increase secondary electrons.

The first, second, and third electrode portions 181, 182, and 183 and the connecting portions 184 of each of the X electrodes 180 may have a single-layered structure. The first, second and third electrode portions 181, 182, and 183 and the connecting portions 184 of each of the X electrodes 180 may have a multiple-layered structure. If the first, second, and third electrode portions 181, 182, and 183 and the connecting portions 184 of each of the X electrodes 180 have a multiple-layered structure, each of the layers may be made of same or different materials.

To simplify the manufacturing process, the first, second, and third electrode portions 181, 182, and 183 and the connecting portions 184 of each of the X electrodes 180 may be integrated. For example, each of the X electrodes 180 may be formed as a thick layer in a printing method using, e.g., a photosensitive paste, or may be formed as a thin layer in a sputtering or evaporation method.

As shown in FIG. 4, in embodiments of the invention, the first, second, and third electrode portions 181, 182, and 183 may be formed to have a line width B, along the y-direction, and the connecting portions 184 may have a line width S, along the x-direction.

To improve brightness and reduce power consumption, the relative ratio (S/B) of the line width S of the connector 184 and the line width B of the first, second, and third electrode portions 181, 182, and 183 may satisfy the following relationship 1.00≦S/B≦1.70, and the line width B of the first, second, and third electrode portions 181, 182, and 183 may be about 20 μm to about 150 μm. The line width B of the first, second, and third electrode portions 181, 182, and 183 and the line width S of the connector 184 will be described in more detail below.

Each of the Y electrodes 190 may include a first electrode portion 191, a second electrode portion 192, a third electrode portion 193, and connecting portions 194. To help generate uniform discharge, the Y electrodes 190 may be formed symmetrically to the X electrodes 190 in each of the discharge cells 170. Because the structures, functions, and materials of the first, second, and third electrode portions 191, 192, and 193 and the connecting portions 194 are similar to those of the first, second, and third electrode portions 181, 182, and 183 and the connecting portions 184 of the X electrodes 180, their descriptions will be omitted.

As discussed above, for one of the discharge cells 170, the corresponding first, second and third electrode portions 181, 182, and 183 of the corresponding X electrode may be arranged substantially at one side of the discharge cell 170, and the corresponding first, second and third electrode portions 191, 192, and 193 of the corresponding Y electrode 190 may be arranged at another side of the discharge cell 170. For example, a first electrode portion 191 may be arranged substantially at one side of the discharge cell 170, the third electrode portion 193 may be arranged substantially at a center of the discharge cell 170, the second electrode portion 192 may be arranged substantially between the first electrode portion 191 and the third electrode portion 193 of the Y electrode 190, the third electrode portion 183 of the X electrode 180 may be arranged substantially at the center of the discharge cell 170, the first electrode portion 181 may be arranged substantially at another side of the discharge cell 170, and the second electrode portion 182 may be arranged substantially between the first electrode portion 181 and the third electrode portion 183 of the X electrode 180. A predetermined space may exist between each adjacent ones of electrode portions 181, 182, 183, 191, 192, 193 of one of the discharge cells 170, such that the predetermined space exists between, e.g., the third electrode portion 183 of the X electrode 180 and the third electrode portion 193 of the Y electrode. In embodiments of the invention, different distances may exist between adjacent ones of the electrode portions 181, 182, 183, 191, 192, 193 associated with one discharge cell 170. In embodiments of the invention, although different distances may exist between adjacent ones of the electrode portions 181, 182, 183, 191, 192, 193 associated with one discharge cell 170, the pattern of distances may be repeated for each of the discharge cells 170.

In embodiments of the invention, a space between the third electrode portion 183 of the X electrode 180 and the third electrode portion 193 of the Y electrode 190 associated with the same discharge cell may be smaller than the predetermined space between other respective pairs of the electrode portions, e.g., between the first electrode portion 181 and the second electrode portion 182 of one of the X electrodes. As discussed below, a corresponding one of the Y electrodes 190 associated with the same discharge cell 170 may be symmetrically arranged, as discussed below, over the other side of the discharge cell 170.

Light absorbing layers 140 may be disposed between adjacent pairs of sustain electrodes 112, e.g., between each pair of one of the X electrodes 180 and one of the Y electrodes 190. The light absorbing layers 140 may be disposed on portions of the first substrate 111 corresponding to the second barrier ribs 130b. The light absorbing layers 140 may absorb external light incident thereon to reduce reflected brightness, thereby improving bright room contrast. When the light absorbing layers 140 are made of the same material as the X and Y electrodes 180 and 190, the light absorbing layers 140 and the X and Y electrodes 180 and 190 can be formed during the same process, and thus the manufacturing process of the PDP 100 is simplified. In embodiments of the invention, a line width C of the light absorbing layers 140 may be about 50 μm to about 200 μm.

The first dielectric layer 115 may be formed on the first substrate 111 to cover the X and Y electrodes 180 and 190. The first dielectric layer 115 may be made of a dielectric material that prevents an electrical short between adjacent X and Y electrodes 180 and 190 during the discharge and prevents damage to the X and Y electrodes 180 and 190 by reducing and/or preventing positive ions or electrons from directly colliding with the X and Y electrodes 180 and 190 during discharge. Wall charges may be formed on the first dielectric layer 115. Examples of a dielectric material include, e.g., PbO, B₂O₃, and SiO₂.

The protective layer 116 made of, e.g., MgO, may be formed on the first dielectric layer 115. The protective layer 116 reduces and/or prevents damage to the first dielectric layer 115 by reducing and/or preventing the positive ions and electrons from colliding with the first dielectric layer 115 during the discharge. The protective layer 116 may have good light transmitting properties and may emit secondary electrons during the discharge. The protective layer 116 may be formed, e.g., as a thin layer using, e.g., sputtering, electron beam deposition, etc.

The address electrodes 122 may be formed perpendicular to the X and Y electrodes 180 and 190 on the surface of the second substrate 121 facing the first substrate 111. The address electrodes 122 may generate address discharge to facilitate a sustain discharge between the X and Y electrodes 180 and 190. The address electrodes 122 may lower a voltage at which main discharge occurs. The address discharge may occur between the Y electrodes 190 and the address electrodes 122. When the address discharge terminates, positive ions may be accumulated on the Y electrodes 190 and electrons may be accumulated on the X electrodes 180. As a result, a subsequent sustain discharge between the X and Y electrodes 180 and 190 is facilitated.

The second dielectric layer 125 may be formed on the second substrate 121 to cover the address electrodes 122. The second dielectric layer 125 may be made of a dielectric material and may prevent and/or reduce damage to the address electrodes 122 by preventing the positive ions or electrons from colliding with the address electrodes 122 during a discharge. Also, wall charges are induced in the second dielectric layer 125. Examples of the dielectric material include, e.g., PbO, B₂O₃, and SiO₂.

The phosphor layers 126 from which red, green, and blue light can be emitted may be formed on the second dielectric layer 125. In embodiments of the invention, the phosphor layers 126 may be formed on the second dielectric 125, except for where the barrier rib unit 130 is formed, and on the sidewalls of the barrier rib unit 130. The phosphor layers 126 may receive UV light and may emit visible light. Phosphor layers 126 for respectively emitting red, green and blue light may be respectively formed in red, green and blue discharge cells 170. Phosphor layers 126 for emitting red light may include, e.g., Y(V,P)O₄:Eu, phosphor layers 126 for emitting green light may include, e.g., Zn₂SiO₄:Mn, and phosphor layers 126 for emitting blue light may include, e.g., BAM:Eu.

The discharge gas, which may be, e.g., a mixture of Ne and Xe, may fill the discharge cells 170. The first and second substrates 111 and 121 may be sealed and coupled to each other by a sealing element, e.g., frit glass, formed at the edges of the first and second substrate 111 and 121 while the discharge cells 170 are filled with the discharge gas.

Exemplary operation of the PDP 100 will be described below.

An address discharge may occur when an address voltage is applied between corresponding ones and/or portions of the address electrodes 122 and the Y electrodes 190. The address discharge may be used to address or select the discharge cells 170 in which sustain discharge is to occur during a subsequent sustain period.

A sustain voltage may then applied between corresponding ones or portions of the X and Y electrodes 180 and 190, and in the addressed or selected ones of the discharge cells 170, positive ions that may have accumulated on the Y electrodes 190 and electrons that may have accumulated on the X electrodes 180 may collide with each other, thereby generating sustain discharge. A voltage pulse may be alternately applied to the X and Y electrodes 180 and 190, and thus the sustain discharge may be continuously generated. During the sustain discharge between the X and Y electrodes 180 and 190, a discharge may initially occur between respective ones of the third electrode portions 183 of the X electrodes 180 and the third electrode portions 193 of the Y electrodes 190, where a discharge gap may be smallest. Thereafter, discharge may continually spread to the second electrode portions 182 and 192 and the first electrode portions 181 and 191.

UV light may be emitted as an energy level of the discharge gas excited during the sustain discharge decreases. The emitted UV light may excite the phosphor layers 126 that may be provided in the discharge cells 170. When an energy level of the excited phosphor layers 126 is decreased, visible light may be emitted, thereby displaying an image.

Although the X and Y electrodes 180 and 190 may generate sustain discharge, they may block the visible light generated in the discharge cells 170 from being emitting to the outside via the first substrate 111. When the electrode areas of the X and Y electrodes 180 and 190 are increased, the amount of visible light generated can be increased because discharge may more readily be generated. However, by increasing the electrode areas, an aperture ratio is reduced, thereby reducing an overall brightness of the display and increasing, unnecessarily, power consumption. To overcome these problems, structures of the X and Y electrodes need to be selectively designed.

In the following description, surface area corresponds to an area along a surface of a structure, e.g., third electrode portion 192 of the Y electrode 190, along the x-z or y-z plane, which faces an adjacent one of the electrode portions e.g., 181, 182, 183, 191, 192, 193, or another one of the connecting portions 184, 194.

In embodiments of the invention, structures of the X and Y electrodes may be optimized by increasing surface areas of the first, second, and third electrode portions 181, 182, and 183 of the X electrodes 180 and the first, second, and third electrode portions 191, 192, and 193 of the Y electrodes 190 because the first, second, third electrode portions 181, 182, 183, 191, 192, and 193 of the sustain electrodes 112 are important components in generating plasma discharge. As discussed above, in embodiments of the invention, the first, second, third electrode portions 181, 182, 183, 191, 192, and 193 of the sustain electrodes 112 may be arranged parallel to each other.

In embodiments of the invention, surface areas of the connecting portions 184 of the X electrodes 180 and the connecting portions 194 of the Y electrodes 190 facing each other may be smaller than the surface areas of the first, second, and third electrode portions 181, 182, 183, 191, 192, 193. In embodiments of the invention, the connecting portions 184 and 194 may be disposed substantially along a center portion of the discharge cells 170, which is generally where discharge occurs the most. Thus, the connecting portions 184, 194 may have a large effect on the transmittance of visible light generated in the discharge cells 170.

Even if the connecting portions 184, 194 have smaller surface areas for facing surfaces and may thus, be disadvantaged in relation to the electrode portions 181, 182, 183, 191, 192, 193, the connecting portions 184 of the X electrodes 180 are advantageous in helping diffuse the discharge so that the sustain discharge may occur in a space, e.g., between the third and second electrodes 183 and 182 of the X electrodes 180 and in a space between the second and first electrodes 182, and 181 of the X electrodes 180. Similarly, the connecting portions 194 of the Y electrodes 190 help diffuse the discharge so that sustain discharge may occur in a space, e.g., between the third and second electrodes 193 and 192 of the Y electrodes 190 and in a space between the second and first electrodes 192, and 191 of the Y electrodes 190. In embodiments of the invention, the size of the connecting portions 184 and 194 may be determined considering characteristics of the connecting portions 184 and 194 that increase brightness by facilitating the discharge, but also reduce brightness by blocking visible light.

In embodiments of the invention, the line widths B of the first, second, and third electrode portions 181, 182, and 182 of the X electrodes 180 and the first, second, and third electrode portions 191, 192, and 192 of the Y electrodes 190 and the line width S of the connecting portions 184 and 194 of the X and Y electrodes 180 and 190 may be used as parameters for increasing brightness. For example, the relative ratio (S/B) of the line width S of the connecting portions 184 to the line widths B of the first, second and third electrode portions 181, 182 and 183 of the X electrodes 180 is a dimensionless parameter that may be used to achieve optimum brightness and power consumption.

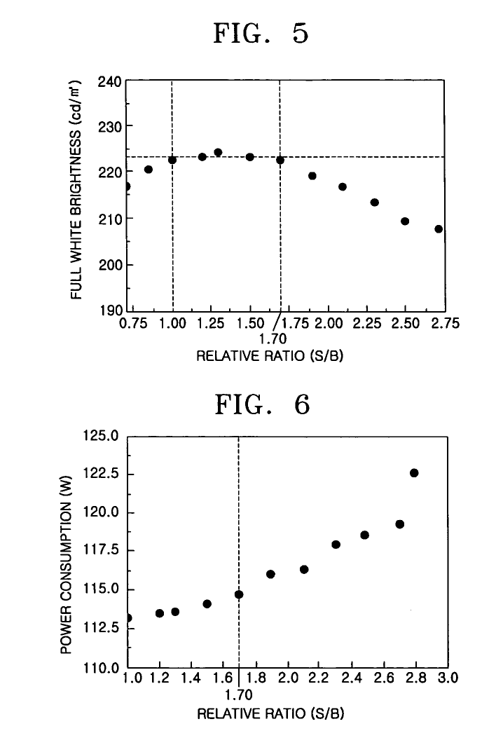

FIG. 5 is a graph of full white brightness with respect to the relative ratio (S/B) of the line widths S of the connecting portions 184 to the line widths B of the first, second, and third electrode portions 181, 182, and 183 of one of the X electrodes 180. The full white brightness corresponds to brightness measured when discharge is generated in all discharge cells of a PDP.

In the present experiment, the line widths B of the first, second, and third electrode portions 181, 182, and 183 of the X electrodes 180 and the line widths B of the first, second, and third electrode portions 191, 192, and 193 of the Y electrodes 190 were maintained at 55 μm, and the line width C of the light absorbing layer 140 was maintained at 75 μm. Referring to FIG. 4, a distance D2 between the first and second electrode portions 181 and 182 of the X electrodes 180 and a distance D1 between the second and third electrodes 182 and 183 of the X electrodes 180 were maintained at 95 μm. A distance E2 between the first and second electrode portions 191 and 192 of the Y electrodes 190 and a distance E1 between the second and third electrodes 192 and 193 of the Y electrodes 190 were maintained at 95 μm. The distance G between the third electrode portion 183 of the X electrode 180 and the third electrode portion 193 of the Y electrode 190 was maintained at 95 μm. The distance F1 between the first electrode portion 181 of the X electrode 180 and the light absorbing layer 140 and the distance F2 between the first electrode portion 191 of the Y electrode 190 and the light absorbing layer 140 were maintained at 115 μm. In the present experiment, the line widths S of the connecting portions 184 and 194 were altered to change the relative ratio (S/B).

Referring to FIG. 5, when the relative ratio (S/B) was 0.70, 0.85, 1.00, 1.20, 1.30, 1.50, 1.70, 1.90, 2.10, 2.30, 2.49, 2.70, and 2.80, the full white brightness was 216.90, 220.60, 222.62, 223.20, 224.11, 223.30, 222.80, 219.14, 216.73, 213.29, 209.12, 207.54, and 205.23, respectively.

When analyzing the graph illustrated in FIG. 5, the full white brightness increased by about 0.92% when the relative ratio (S/B) increased from 0.85 to 1.00. Also, when the relative ratio (S/B) increased from 1.70 to 1.90, the full white brightness greatly decreased by about 3.19%. In particular, the full white brightness was high while the relative ratio (S/B) was maintained in a predetermined range when 1.00≦S/B≦1.70. That is, when the relative ratio (S/B) satisfied the following relationship 1.00≦S/B≦1.70, the areas of the connecting portions 184 and 194 connected to the first, second, and third electrode portions 181, 182, and 183 of the X electrode 180 and the first, second, and third electrode portions 191, 192, and 193 of the Y electrode 190 may be optimized. As a result, the increase in brightness by discharge is relatively greater than the decrease in brightness caused by blockage of visible light when the relative ratio (S/B) satisfies the following relationship 1.00≦S/B≦1.70.

FIG. 6 is a graph illustrating power consumption when performing the experiment of FIG. 5. Referring to FIG. 6, as the relative ratio (S/B) increased, power consumption increased. In particular, when the relative ratio (S/B) increased from 1.70 to 1.90, the power consumption increased by 1.12%. Compared to the increase in power consumption as the relative ratio (S/B) increased to 1.70, the power consumption increased more quickly as the relative ratio (S/B) increased above 1.70. Therefore, when considering both power consumption and brightness, the relative ratio (S/B) may be 1.70 or less.

Embodiments of the invention provide a PDP having optimized line widths for electrode portions and connecting portions of sustain electrodes, and thus, increased brightness and reduced power consumption.

Embodiments of the invention separately provide a PDP that may employ sustain electrodes that may be formed during a single processing step and/or employing one type of material, thereby reducing a cost of the PDP and/or simplifying the manufacturing process of the PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP) comprising:
first and second substrates facing each other and separated by a predetermined distance; and
a plurality of pairs of sustain electrodes that are interposed between the first and second substrates for generating discharge, each of the plurality of pairs of sustain electrodes including:
a plurality of electrode portions; and
connecting portions which electrically connect the electrode portions,
wherein a relative ratio (S/B) of line widths (B) of one of the electrode portions to line widths (S) of one of the connecting portions satisfies a relationship of 1.00≦S/B≦1.70.

2. The PDP as claimed in claim 1, wherein the electrode portions of each sustain electrode extend parallel to each other.

3. The PDP as claimed in claim 1, wherein each sustain electrode comprises two to four electrode portions extending parallel to each other.

4. The PDP as claimed in claim 1, wherein the connecting portions and the electrode portions extend perpendicular to one another.

5. The PDP as claimed in claim 1, wherein the line widths of the electrode portions are about 20 μm to about 150 μm.

6. The PDP as claimed in claim 1, wherein the line widths of the electrode portions of each sustain electrode are substantially equal.

7. The PDP as claimed in claim 1, wherein the connecting portions and the electrode portions of each sustain electrode are integrated.

8. The PDP as claimed in claim 1, wherein the connecting portions are disposed at substantially center portions of the discharge cells.

9. The PDP as claimed in claim 1, wherein the sustain electrodes include at least one of a conductive metal material and a ceramic material.

10. The PDP as claimed in claim 9, wherein the sustain electrodes include at least one metal material selected from the group consisting of Ag, Pt, Pd, Ni and Cu.

11. The PDP as claimed in claim 9, wherein the sustain electrodes include at least one of indium doped tin oxide and antimony doped tin oxide.

12. The PDP as claimed in claim 1, wherein the sustain electrodes include carbon nanotubes.

13. A PDP comprising:
first and second substrates facing each other and separated by a predetermined distance;
a plurality of barrier rib units interposed between the first and second substrates and at least partially defining a plurality of discharge cells;
address electrodes extending across the discharge cells;
a plurality of pairs of sustain electrodes that intersect the address electrodes, cause discharge, and include:
a plurality of electrode portions which crosses the address electrodes and connecting portions which electrically connect the electrode portions;
phosphor layers formed in the discharge cells; and
discharge gas in the discharge cells,
wherein a relative ratio (S/B) of line widths (B) of one of the electrode portions to line widths (S) of one of the connecting portions satisfies a relationship of 1.00≦S/B≦1.70.

14. The PDP as claimed in claim 13, wherein the connecting portions of each sustain electrode are disposed in each of the discharge cells.

15. The PDP as claimed in claim 13, further comprising light absorbing layers to absorb light incident from outside of the PDP.

16. The PDP as claimed in claim 15, wherein the barrier ribs comprises:
first barrier ribs disposed parallel to the address electrodes extends; and
second barrier ribs disposed intersecting the first barrier ribs, and
the light absorbing layers are disposed to at least partially overlap the second barrier ribs.

17. The PDP as claimed in claim 15, wherein the light absorbing layers are formed in stripes.

18. The PDP as claimed in claim 15, wherein line widths of the light absorbing layers are about 50 μm to about 200 μm.

19. The PDP as claimed in claim 13, further comprising:
a first dielectric layer covering the sustain electrodes; and
a second dielectric layer covering the address electrodes.
